(19) United States
(12) Patent Application Publication
(10) Pub. No.: US 2015/0122942 A1
(43) Pub. Date: May 7, 2015

(54) METHOD FOR GENERATING LIFT AND A DEVICE FOR IMPLEMENTING METHOD

(71) Applicants: Raimo Hirvinen, Hyvinkaa (FI); Jani Hirvinen, Bangkok (TH); Toni Hirvinen, Hyvinkaa (FI)

(72) Inventors: Raimo Hirvinen, Hyvinkaa (FI); Jani Hirvinen, Bangkok (TH); Toni Hirvinen, Hyvinkaa (FI)

(21) Appl. No.: 14/376,537

(22) PCT Filed: Feb. 6, 2012
(86) PCT No.: PCT/FI2012/050107

§ 371 Date: Dec. 4, 2014

(51) Int. Cl. B64C 1/00; B64C 3/14

(52) U.S. Cl. CPC B64C 1/0009; B64C 3/14
USPC 244/36

(57) ABSTRACT

The object of the invention is a method for generating lift for an airborne flying device, which has a wing part and/or a fuselage part generating lift by means of interactive movement between the air and the device. In the method, in the frontal view area of the lift-generating part of the device is arranged at least one counterflow impulse surface (1), which is formed by a planar or curved surface extending forward in the direction of travel from the lower surface (2) of the wing and/or fuselage and obliquely upwards, and which generates at least the main part of the lift when the airflow hits this inclined impulse surface and bends when the device is airborne.

The object of the invention is to provide a method for generating lift which deviates from Bernoulli's law and is based on a different type of phenomenon for generating lift for a subsonic airborne device, as well as a wing profile/an airfoil, a wing and/or a fuselage for implementing the said method.

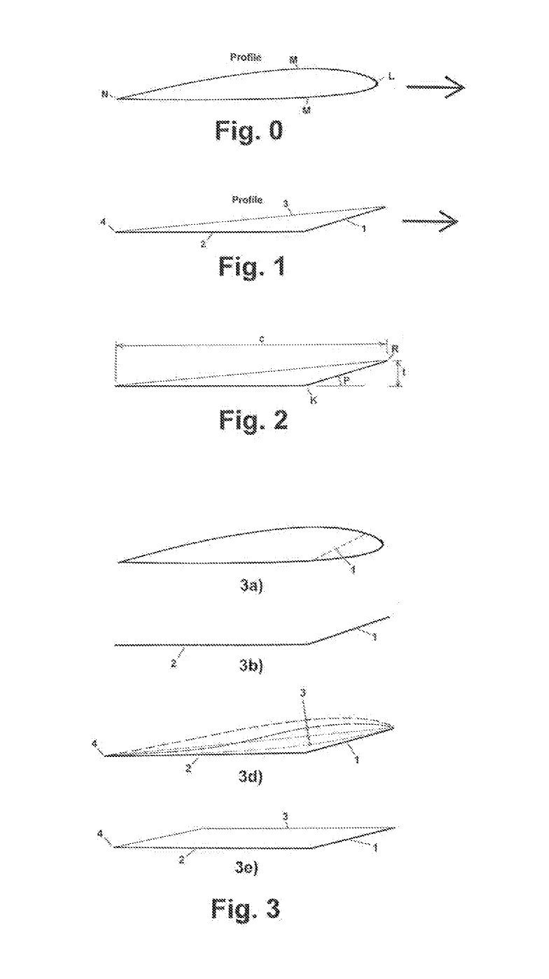

Nowadays, the lift of airborne flying devices, for instance the lift of the wing of an airplane, is generated by means of conventional, widely used wing profiles or airfoils, which are based on Bernoulli's law (FIG. 0). According to it, the rate of flow becomes higher on the curved upper surface of the wing profiles than on the lower surface and creates negative pressure on the upper surface of the wing and most of the lift which carries a device heavier than air in the air. The weight of a small airplane is about 600 kg, and that of a big airliner is as high as 550 000 kg. Their corresponding wing loads are about 50 kg/m2 and about 800 kg/m2, and corresponding cruising speeds about 200 km/h and 900 km/h, in other words completely different. A common feature between them is, however, that in horizontal flight, about ⅔ of the lift is generated by negative pressure on the upper surface of the wing and about ⅓ by positive pressure on the lower surface of the wing. The general shape of the cross-section of the wing, that is, of the wing profile, where a round leading edge is usually followed by curved upper and lower surfaces and a sharp tail, that is, trailing edge, is also common to both of them. An example of such wing profile is illustrated in FIG. 0.

The object of the invention is to provide a different method for generating lift and a wing profile applicable to the method and a wing for generating lift to a subsonic airborne flying device which comprises control surfaces required for steering, i.e. a rudder and an elevator and ailerons or spoilers, or which is a so-called flying device controlled by the centre of gravity.

It is characteristic of the method according to the invention that in the frontal area view of the lift-generating part of the device is arranged at least one counterflow impulse surface, which is formed by a planar or curved surface extending forward in the direction of travel from the lower surface of the wing and/or fuselage, that is, against the flow and obliquely upwards, and which generates at least the main part of the lift when the airflow hits this inclined impulse surface of the wing and/or fuselage, bending and streaming downwards, while at the same time generating lift according to Newton's third law.

The device according to the invention is in turn characterized in that in the frontal area view of the wing and/or fuselage of the device, in accordance with the wing profile, is a counterflow impulse surface (1), which is formed by a planar or curved surface extending obliquely forward and upward in the direction of travel from the lower surface of the wing and/or fuselage of the device and which generates lift when the airflow hits this inclined impulse surface (1) (FIG. 1).

The invention is described in greater detail in the following, with reference to the accompanying drawings, in which:

FIG. 0 shows a conventional prior art wing profile, in which (L) indicates the round leading edge, (M) the curved lower and upper surfaces, (N) the sharp trailing edge.

FIG. 1 shows an example of the wing profile according to the invention, which comprises an impulse surface (1), a lower surface (2), an upper surface (3) and a trailing edge (4).

FIG. 2 shows an embodiment of a lift generating wing profile according to the method of the invention, where (c) is the chord length of the profile, (f) is the thickness of profile, (K) is the connection point of the lower surface and impulse surface, (P) is the angle between the lower surface and the impulse surface, (R) is the connection point of the upper surface and impulse surface.

FIG. 3 shows further examples of the profile according to the invention; 3a) shows a conventional prior art profile on the round leading edge of which is, as an example, marked by a dashed line the possible location of the impulse surface, 3b) is an open profile with only a lower surface and an impulse surface but no upper surface, 3d) is a profile with alternative upper surfaces of various shapes, 3e) is a rhomboid-shaped profile. In all these examples, (1) indicates the impulse surface.

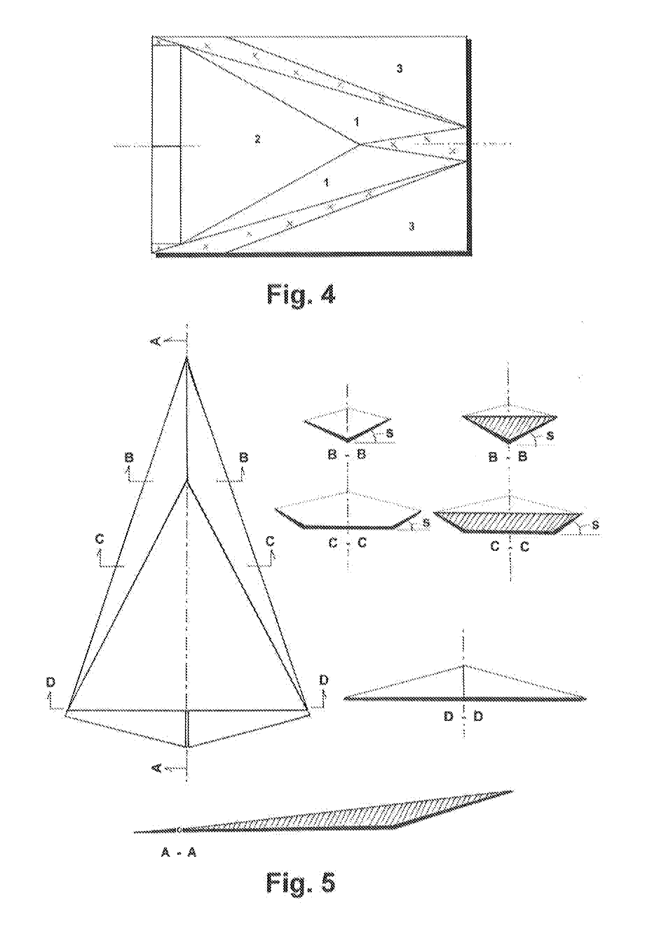

FIG. 4 shows an example according to the method of cutting the flat-surface parts required for building a device, which flies in ground effect or above it, from a board on which the parts are numbered (1),(2),(3), as in FIG. 1, and in addition the control surface boards (5).

FIG. 5 shows a top view of, for example, a WIG according to the invention which flies in ground effect, and cross-sections, which are either open or equipped with upper surfaces at points B-B, C-C and D-D. The cross-sectional views B-B and C-C of the front of the fuselage show an angle (S), of 0-90°, preferably of 15-45°, between the horizontal imaginary extension of the lower surface of the example fuselage and the impulse surface.

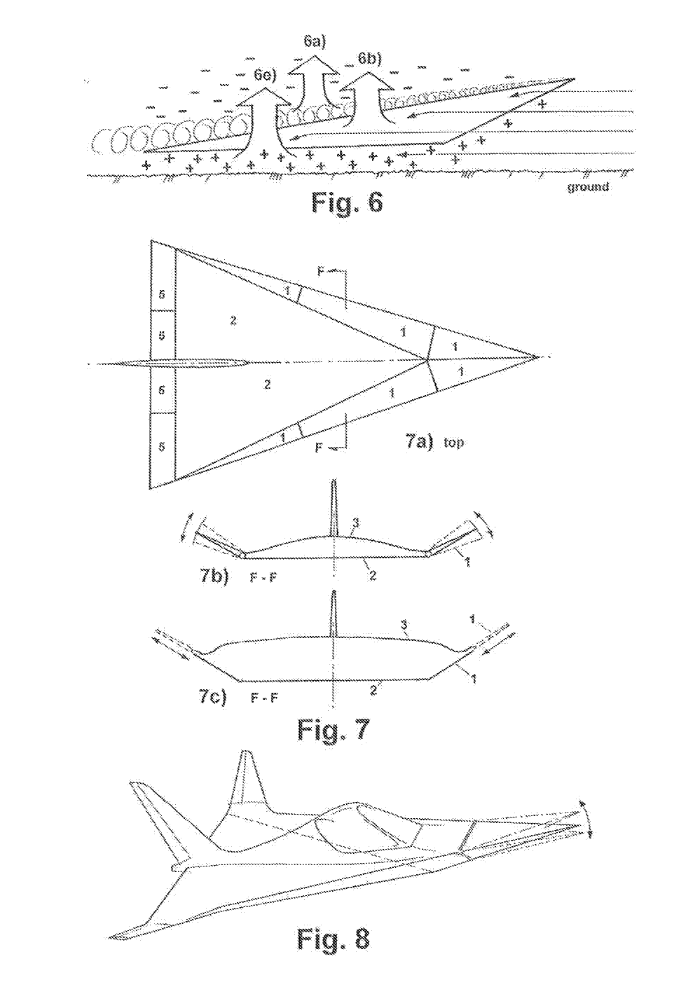

FIG. 6 shows the partial lift forces generated by the example device, where 6a) illustrates the lift of upper surface of the device and the negative pressure field, and the vortices formed on the upper surface of the edges by an arrow-shaped device; 6b) illustrates lift and an air flow, which bends downwards and sideways when it hits the impulse surface, thus generating a substantial proportion of the lift according to Newton's law and stabilizes the device with respect to the vertical and horizontal axes; 6e) illustrates the positive pressure generated by the airflow bent under the device and the ground effect contributing to the lift.

FIG. 7 FIG. 7a) shows the flying device seen from above, 7b) shows the turning impulse surfaces, and 7c) is an example of impulse surfaces with variable surface areas.

FIG. 8 shows an example of a flying device, where the nose section turns up and down with respect to the transversal axis to form an impulse surface.

FIGS. 1 and 2 show an example according to the present method of a wing profile provided with an impulse surface (1) creating lift, also indicating other essential features of the profile. The impulse surface is arranged on the leading edge of the lower surface of the wing and/or fuselage in the direction of travel of the device and it is directed forward and obliquely upward at an angle (P) of 2-75°, preferably 15-45° the said angle being formed with the imaginary line drawn from the trailing edge and passing through the connection point (K) and against the flow (FIG. 2). The following features are typical of the wing profile: the thickness (t) of the profile is 3-30% of the chord (c), the connection point (K) of the lower surface and the impulse surface is on the lower surface of the wing profile, backwards from leading edge, in an area which is 4-45%, preferably 20-40% of chord (c), backwards from the leading edge of the profile, at connection point (K), angle (P) is 2-75°, preferably 15-45° (FIG. 2).

Angle (P) is the angle between the imaginary line continuing from the trailing edge, via the connection point (K) on the lower surface and forward therefrom and the impulse surface. When a fuselage is concerned or, for example, a flying wing, the chord (c) of the wing profile is replaced by the length of the fuselage or the device. In this case, too, the attributes of the profile of the fuselage and the impulse surface are the same as in the wing, but the point of reference is now the nose of the device and the tail of the device. The profile according to the invention, that is, the wing or the fuselage, is formed by flat or curved upper and lower surfaces and an impulse surface between them, which is obliquely against the flow, as described above. The connection (R) between the impulse surface and the upper surface of the profile is sharp, and to it is connected a straight or slightly curved upper surface. The connection (K) between the impulse surface and the lower surface is angular or slightly rounded, and the trailing edge is acute-angled (FIG. 2).

An earlier prior art wing profile based on Bernoulli's law can be modified into a wing profile of the present invention generating lifting power in accordance with Newton's third law by removing the round leading edge from the point indicated by the dashed line in the example profile (FIG. 3a) by fixing a flat surface, an impulse surface, between the upper and lower surfaces of this wing. The profile of the wing or fuselage may consist of only a lower surface and an impulse surface connected to it, that is, it may be an open model (FIG. 3b), but the profile generally also has an upper surface (FIG. 3d), which curves slightly upwards or downwards or is straight, in which case the profile resembles an oblique triangle. FIG. 3e shows a rhomboid-shaped profile.

In wing or an elevator, the wing profile according to the invention improves, among other things, the distribution of overall lift, because the elevator does not need to generate negative, downwards directed lift in order to balance the “nose down” torque produced by previously used wing profiles and structures, but instead it also generates an upwards directed force and thus increases the overall lift instead of reducing it. Due to this and other different properties of the profile can be built multi-wing constructions, where several successive wings are arranged successively and/or on top of one another. The center of gravity (Cg) and the aerodynamic center (AC) must obviously be taken into account. It is also possible to construct various “flying bodies”, “flying wings” or spacecrafts of “space shuttle” or SST (Super Sonic Transport) type. Another feature of the profile is that it settles in an attitude of flight based on flying speed, which is useful for the maneuverability of the plane. This wing profile is applicable for use in various types of wings, including straight, tapered, elliptical, canard, swept-back and delta wings, as well as fuselages and their combinations. The upper leading edge of a wing provided with an impulse surface is generally straight-lined, but a “serrated” leading edge of the upper surface creates useful vortices on the wing profile according to the present invention also in straight wings, the said vortices affecting the lift of the wing.

Applications of a fuselage and/or a wing or wing-like device equipped with an impulse surface include various flying devices, WIGs, land vehicles and water-crafts, which can be lifted into the air by means of the solution according to the invention. A wing profile equipped with the impulse surface according to the invention can also be used in propellers, helicopter blades and windmill vanes and as sails. Different types of sports equipment for summer and winter sports and recreation, such as “flying water skis”, “flying water sled”, “flying downhill sled” and “real flying ski jump skis” as well as rescue equipment such as rafts towed in the air and, for example, kites which rise from the ground due to the action of this impulse surface and the effect of wind. Suitable building materials are those previously used for airplanes, cars and ships, such as various plastics, plastic films, fabrics, thin film-like materials as well as the new nanomaterials. The devices are made to move to generate lift in the air by means of current engines, but due to the climatic change, electric engines with accumulators are recommended for their environmental friendliness. The invention makes it possible to construct an “everyman's flying car”. Devices without their own engines are towed or slung into the sky in the same way as gliders or paragliders of various types.

A WIG (Wing-in-Ground-Effect craft) constructed in accordance with the present method uses a profile shape complying with this principle in its fuselage. A WIG constructed in accordance with the invention does not suffer from the instability problems which occur when the device leaves the ground or water surface and begins to fly in the air. The device is also stable and quick in turns and it does not slide sideways, but it is precisely controllable in its flying state, contrary to current WIGs which require a wide turning radius and a large area for turning.

FIG. 4 shows an example of a method of how to cut the parts of, for example, a triangular flying fuselage or WIG according to the invention from flat board. The invention is utilized in producing an arrow-shaped, A-shaped flying device with a fairly sharp angle in the front. The inclined sides of this fuselage, the impulse surfaces, are connected to the front edges of the triangular lower surface. This lower surface (2) (FIG. 5) is straight or has a gently sloping V-angle. The impulse surfaces are connected to the oblique front edges of the triangular lower surface or to the edges of a device with a square base at an angle of 0°-90°, preferably 15°-45°, inclined upwards and outwards, angle (S) (FIG. 5). They thus form a profile and a device with an open upper surface which is capable of flying either in ground effect or also above it. The protective upper surface of the flying device is constructed so as to be essentially closed with either a straight or curved top construction. It does not need to be of the same shape as the lower surface. The parts required for moving on land or in water are connected to the bottom of the device.

FIG. 6 shows an example of partial lift forces generated by the device. When flying in ground effect, a positive pressure force generating lift is formed between the device and the surface and this is known as the ground effect. Its effect reaches at most to the height of the wing span of the device from the surface below (6e). When flying above this height, the lower surface and the outwards inclined impulse surfaces generate the main part of the lift because the air flow hitting the bottom and the oblique impulse surfaces according to the invention is forced to bend downwards. A counterforce is then created in the known manner according to Newton's third law and exerted on the said surfaces (6b). The negative pressure created on the upper surface generates a part of the lift even in horizontal flying, but it strengthens when the angle of attack increases, whereby vortices further increasing the lift are generated on the upper surface of the device due to the effect of the arrow-shaped edges of the impulse surfaces (FIG. 6a). The impulse surfaces generate not only lift, but also forces for stabilizing direction and banking. The forces generated are dependent on, for example, air density, the speed of the device, the wing span of the device, the area of the impulse surface and the inclination and direction of the impulse surface with respect to the flow, and in the case of a WIG, also on its distance/height from the ground or water surface below.

Test flight programs with an almost 2.5-meter-long, radio-controlled prototype of the constructed device confirmed the theoretical view that it is useful to be able to turn (FIG. 7b) the impulse surfaces and/or to vary their surface areas in order to regulate lift. These adjustments affect the behavior of the device very little, thanks to its inherent stability. The location of the center of gravity obviously has to be taken into account when the aim is to affect the performance of the device, such as its gliding properties, maximum and minimum flying speeds, stalling properties, as well as the length of take-off or landing runs. When approaching a stalling situation, the device tends to straighten itself and in high speed flying it lifts its nose and limits the speed. Due to its aerodynamics, the device according to the invention corrects the above-mentioned “flight error situations” in advance and thus shows good speed and position stabilities.

The development of the conventional airplane took a long time. The development work of the flying device according to the invention is at the beginning and brings new challenging prospects.

1. A method for generating lift for a flying device, which is a mere fuselage or body with or without wing part, generating lift and stability by the help of specially arranged surfaces and by means of interactive movement between the air and the device, wherein the aspect ratio of arrow-shaped and angular device is formed small, and the specially arranged surfaces are straight or slightly curved side surfaces (1) extending along the main part of the length of the device and these surfaces are organized symmetrically and in an arrow shaped position like letter A in relation to the longitudinal axis of the device and are made slanted outwards like letter V and these side surfaces or impulse surfaces are connected by the lower surface (2), and optionally also by an upper surface (3), and these surfaces organized in this way will create both lifting and stabilizing forces simultaneously in relation to the longitudinal axis, lateral axis and vertical axis from which forces the main part is formed by the slanted impulse surfaces (1) and the rest by the lower and upper surfaces when the airflow hits the surfaces and bends downwards and sideward creating reaction forces on the surfaces, and the structural form and aerodynamics of the device restricts its maximum speed and in slow flight region will correct itself before stall has fully developed.

2. A method as claimed in claim 1, wherein at least one of the impulse surfaces (1) or a part of it in the fuselage and/or in the wing part of the device generating lift and/or stability can be turned and/or its surface area can be varied in order to regulate the lift and the performance of the device.

3. A method as claimed in claim 1, wherein the said at least one impulse surface is/the said impulse surfaces are arranged symmetrically with respect to the longitudinal axis of the device in the fuselage and/or in the wings and/or in the elevator or in another surface.

4. A flying device with a fuselage part and/or wing part generating lift and stability by means of interactive movement between the air and the device, wherein the part in the device which creates major part of lift and stability is formed by straight or slightly curved impulse surfaces (1) which extend along the main part of the length of the device and these surfaces are arranged symmetrically and in an arrow shaped position with respect to the longitudinal axis of the device and these long side surfaces which are slanted outwards like letter V create together with the lower surface and the upper edge lift and stabilizing forces with respect to the longitudinal, lateral and vertical axes when the airflow hits inclined impulse surface and bending downwards and sideward creating reaction forces simultaneously.

5. A device as claimed in claim 4, wherein the impulse surface on the side surface of the fuselage and/or the wing of the device is a flat or slightly curved surface extending slanting upwards, forwards and sideward from the lower surface and where the impulse surfaces are joined to lower surface and this joint line forms an angle of 2-75 degrees, (preferably 4-45) (P) with an imaginary line drawn forward from the connection point (K), which is on the lower surface of the fuselage and/or wing in an area which is 4-45% (preferably 20-40%) of chord (c) or the length of the fuselage and the impulse surface on the side surface of the device is at an angle (S) of 0-90 degrees (preferably 5-60 degrees) with respect to the horizontal plane of the lower surface and is slanting upwards, forwards and sideward.

6. A flying device as claimed in claim 4, wherein in the device rearwards of the lower edge of the impulse surface in the fuselage and/or the wing is arranged a straight or slightly curved lower surface (2) which is a gently sloping V-angled surface, and that the fuselage and/or wing part defined by the impulse surface (1) and the lower surface (2) of the fuselage and/or wing has an open upper surface (=no surface) or is made essentially closed on its upper surface by means of a material which is essentially straight or slightly curved and may differ in shape from the lower surface.

7. A device as claimed in claim 4, wherein the device is arranged to fly in ground effect and/or in the airspace above ground effect.

8. A device as claimed in claim 4, wherein the front part in the nose section of the device with or without impulse ,surface is arranged so as to turn in respect to the transversal axis of the device.

9. A device as claimed in claim 4, wherein the said at least one impulse surface or part of it or part of the upper or lower surface or wing part can be turned and/or its surface area can be varied in order to regulate the lift and/or balance or performance of the device.

10. A device as claimed in claim 4, wherein the leading edge of the fuselage and/or wing of the device with the profile according to application is serrated or toothed.

11-12. (canceled)
